(19) United States
(12) Patent Application Publication
(10) Pub. No.: US 2025/0305340 A1
(43) Pub. Date: Oct. 2, 2025

(54) OPENING AND CLOSING BODY CONTROL DEVICE

(71) Applicant: U-Shin Ltd., Nagano (JP)

(72) Inventors: Toshiyuki TAKAKI, Hiroshima (JP); Masashi DOMOTO, Hiroshima (JP)

(21) Appl. No.: 19/072,017

(22) Filed: Mar. 6, 2025

(30) Foreign Application Priority Data
Mar. 27, 2024 (JP) 2024-051103

(51) Int. Cl. E05F 15/619; E05F 15/70

(52) U.S. Cl. CPC E05F 15/619; E05F 15/70; E05Y 2900/546

(57) ABSTRACT

An opening and closing body control device includes: a drive mechanism that drives an opening and closing body; a speed detection unit that detects a movement speed of the opening and closing body; a manual operation detection unit that detects manual operation of the opening and closing body; a motor control unit that executes automatic control of performing feedback control of movement of the opening and closing body so that a detected value of the movement speed follows a target value; a target value setting unit capable of setting a basic target value as the target value; and a switching unit that causes the motor control unit to start the automatic control when a switching condition is satisfied. When the automatic control is started, the target value setting unit sets, as the target value, a transition period target value gradually changing from an initial value toward the basic target value.

### CROSS REFERENCE TO RELATED APPLICATION

This application claims benefit of priority to Japanese Patent Application No. 2024-051103, filed on Mar. 27, 2024, the entire content of which is incorporated herein by reference.

### BACKGROUND

### Technical Field

The present invention relates to an opening and closing body control device.

### Background Art

JP H 10-138762 A discloses an automatic opening and closing device that executes control for automatically moving a pop-up door as an example of an opening and closing body after the door is manually operated to some extent.

At the time point of switching from manual operation to automatic control, an actual value of a movement speed of a door is manually obtained and thus varies from time to time. On the other hand, a target value of a movement speed for use in the automatic control can be set to a predetermined value. If a deviation of the actual value from the target value of the movement speed is large, behavior of the door might become unstable after switching from the manual operation to the automatic control.

### SUMMARY

An object of the present invention is to stabilize behavior of an opening and closing body after switching from manual operation to automatic control.

One aspect of the present invention is to provide an opening and closing body control device including: a drive mechanism that drives an opening and closing body configured to open and close an opening part of a vehicle body; a speed detection unit that detects a movement speed of the opening and closing body; a manual operation detection unit that detects manual operation of the opening and closing body; a control unit that executes automatic control by feedback control of movement of the opening and closing body so as to cause a detected value of the movement speed to follow a target value; a target value setting unit capable of setting, as the target value, a basic target value that changes according to an elapsed time or a displacement of the opening and closing body from a start time point of the automatic control; and a switching unit that causes the control unit to start the automatic control when a switching condition that the movement speed during detection of the manual operation is equal to or higher than a switching threshold value lower than the basic target value is satisfied, in which when the automatic control is started upon satisfaction of the switching condition, the target value setting unit sets, as the target value, a transition period target value gradually changing from an initial value toward the basic target value in preference to the basic target value.

According to the above configuration, when the automatic control is started, the target value setting unit does not immediately set the basic target value as the target value in the feedback control, but sets the transition period target value as the target value. The transition period target value gradually changes toward the basic target value. Even if the basic target value deviates from the detected value at the start time point of the automatic control, the transition period target value set instead of the basic target value can be a value closer to the detected value. Immediately after the start of the automatic control, the control unit controls the drive mechanism so that the detected value of the movement speed follows such a transition period target value. Therefore, after switching from the manual operation to the automatic control, the opening and closing body can be naturally moved.

According to the present invention, it is possible to stabilize behavior of the opening and closing body after switching from the manual operation to the automatic control.

### BRIEF DESCRIPTION OF DRAWINGS

FIG. 1 is a perspective view illustrating a part of a vehicle to which an opening and closing body control device according to a first embodiment is applied.

FIG. 2 is a block diagram illustrating the opening and closing body control device according to the first embodiment.

FIG. 3 is a graph illustrating a basic target value and a transition period target value.

FIG. 4 is a flowchart illustrating a control method executed by the opening and closing body control device according to the first embodiment.

FIG. 5 is a flowchart continuing from FIG. 4.

FIG. 6 is a flowchart continuing from FIG. 5.

FIG. 7 is a graph illustrating a transition of a movement speed of an opening and closing body.

FIG. 8 is a block diagram illustrating an opening and closing body control device according to a second embodiment.

FIG. 9 is a flowchart illustrating a control method executed by the opening and closing body control device according to the second embodiment.

FIG. 10A is a graph illustrating a transition of a movement speed of an opening and closing body in a case where a detected value is less than a basic target value at an automatic control start time point and a difference between the detected value and the basic target value is relatively large.

FIG. 10B is a graph illustrating a transition of the movement speed of the opening and closing body in a case where the detected value is less than the basic target value at the automatic control start time point and the difference between the detected value and the basic target value is relatively small.

FIG. 10C is a graph illustrating a transition of the movement speed of the opening and closing body in a case where the detected value exceeds the basic target value at the automatic control start time point.

FIG. 11 is a graph illustrating a transition of a movement speed of an opening and closing body according to a comparative example.

### DETAILED DESCRIPTION

In the following, embodiments will be described with reference to the drawings. Note that the same or corresponding elements are denoted by the same reference numerals throughout the drawings, and overlapping of detailed description will be omitted.

### First Embodiment

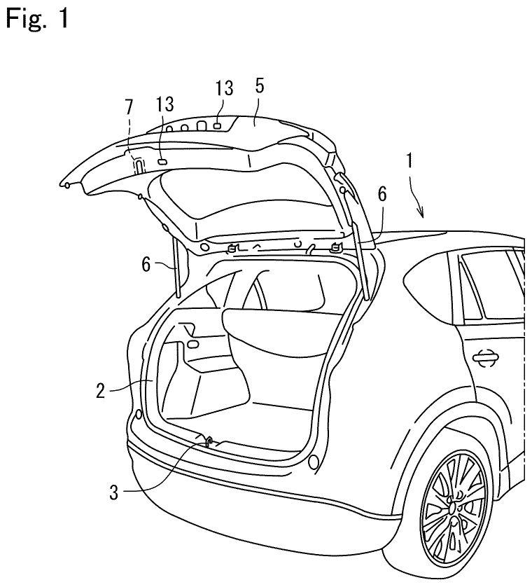

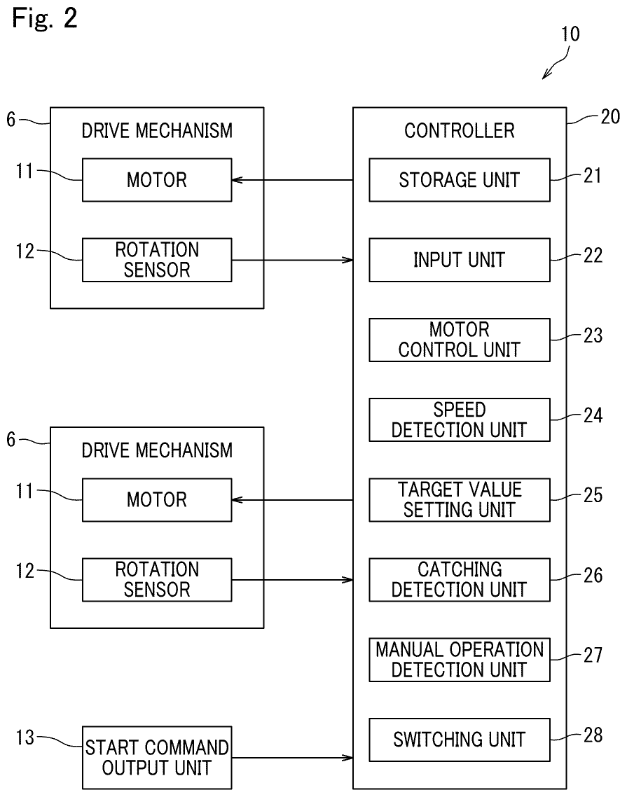

FIG. 1 illustrates a part of a vehicle to which an opening and closing body control device 10 (see FIG. 2) according to the present embodiment is applied. The opening and closing body control device 10 controls movement of an opening and closing body 5 that opens and closes an opening part 2 of a vehicle body 1. The opening and closing body 5 is attached to the vehicle body 1 so as to be displaceable between a fully closed position where the opening part 2 is fully closed and a fully opened position where the opening part 2 is fully opened. Movement of the opening and closing body 5 includes an opening movement of displacing toward the fully opened position and a closing movement of displacing toward the fully closed position. The opening and closing body 5 is driven by a drive mechanism 6.

For example, the opening part 2 is provided at a rear part of the vehicle body 1 to open a passenger compartment or a cargo compartment, the opening and closing body 5 is a back door, and the drive mechanism 6 is a pair of spindle drive mechanisms provided apart from each other in a vehicle width direction. The back door is turnably attached to the vehicle body 1 by hinge connection, and its turning axis extends in the vehicle width direction at an upper edge of the opening part 2. Each spindle drive mechanism is configured as a rod body that expands and contracts according to a rotation direction of the motor 11 (see FIG. 2), and has one end portion pivotally supported by the vehicle body 1 and the other end pivotally supported by the opening and closing body 5. The opening and closing body 5 performs the opening movement according to extension of the rod body, and performs the closing movement according to contraction of the rod body.

The opening and closing body 5 is provided with a latch mechanism 7 that detachably holds a striker 3 provided in the vehicle body 1. By the action of the latch mechanism 7, the opening and closing body 5 can be held at the fully closed position.

With reference to FIG. 2, the opening and closing body control device 10 includes a start command output unit 13 and a controller 20 in addition to the drive mechanism 6 described above. The opening and closing body control device 10 may include a motor that drives the latch mechanism 7 and a sensor that detects a state of the latch mechanism 7.

In the present embodiment, a pair of the drive mechanisms 6 is used to drive one opening and closing body 5. Each drive mechanism 6 has a set of one motor 11 and one rotation sensor 12. Since the two sets are configured similarly to each other, only one set will be described. Note that only one of the pair of drive mechanisms 6 may have the set of the motor 11 and the rotation sensor 12. In this case, the other does not have the set of the motor 11 and the rotation sensor 12, and is driven by the motor 11 provided in the one set.

The motor 11 is rotatable forward and backward, and operates in a rotation direction and at a rotation speed according to a duty ratio of a pulse width modulation (PWM) signal supplied to the motor 11. The rotation sensor 12 outputs a detection signal according to the rotation of the motor 11. The rotation sensor 12 is configured by, for example, a Hall IC. The detection signal is a rectangular wave having a pulse width corresponding to a rotation angle, the number of rotations, or the rotation speed of the motor 11.

The start command output unit 13 outputs a command to start movement of the opening and closing body 5 according to user's operation. Here, the “user's operation” refers to operation of inputting an intention of the user to open or close the opening and closing body 5, rather than operation of directly applying, to the opening and closing body 5, an operation force for the user to operate the opening and closing body 5. The start command output unit 13 outputs the start command in accordance with such operation.

The start command output unit 13 may be configured by a button type switch attached to the opening and closing body 5 or the passenger compartment and operated by the user (see FIG. 1). Although not illustrated in detail, the start command output unit 13 may be configured by a button type switch mounted on an electronic key and operated by a user. The electronic key is carried by the user and is configured to be capable of wirelessly communicating with the controller 20 or an in-vehicle ECU connected thereto. The start command output unit 13 may be configured by a human sensor (e.g., an infrared sensor, a capacitance sensor, or the like) that is provided in the opening and closing body 5 or the vehicle body 1 in the vicinity thereof and detects contact or approach of the user. The “user's operation” includes an action of intentionally causing a part of a body (e.g., a fingertip or a toe) to enter a detection range of the human sensor.

The controller 20 includes, for example, a central processing unit (CPU) or a micro processing unit (MPU) that realizes a predetermined function in cooperation with software. The controller 20 may be configured by a hardware circuit such as a dedicated electronic circuit designed to realize a predetermined function or a reconfigurable electronic circuit, or may be configured by various semiconductor integrated circuits. Examples of the various semiconductor integrated circuits include a microcomputer, a digital signal processor (DSP), a field programmable gate array (FPGA), and an application specific integrated circuit (ASIC), in addition to a CPU and an MPU. Furthermore, the controller 20 may include a storage device such as a random access memory (RAM) and a read only memory (ROM).

The controller 20 includes a storage unit 21, an input unit 22, a motor control unit 23, a speed detection unit 24, a target value setting unit 25, and a catching detection unit 26.

The storage unit 21 can be realized by the above-described storage device. The storage unit 21 temporarily or permanently stores a program for controlling opening and closing movement of the opening and closing body 5 and information for use for executing the program. The input unit 22 acquires the detection signal output from the rotation sensor 12. In addition, the input unit 22 acquires the start command output from the start command output unit 13.

The motor control unit 23 executes automatic control for performing feedback control of the movement of the opening and closing body 5 so that a detected value Vd of a movement speed of the opening and closing body 5 follows a target value Vs. Specifically, in this automatic control, the motor control unit 23 variably sets an operation command value for the motor 11 according to a deviation of the detected value Vd from the target value Vs. The operation command value is, for example, the duty ratio of the PWM signal supplied to the motor 11.

Note that the “movement speed of the opening and closing body 5” to be controlled is not limited to a displacement speed (e.g., a turning speed (rad/s or deg/s) of the back door and a translation speed (mm/s) of a sliding door) of the opening and closing body 5 itself, and may be another speed that can be associated with the displacement speed from a viewpoint of geometry and mechanics. Examples of such other speeds include the rotation speed of the motor 11 (rps, rad/s, or deg/s) and an operation speed of the drive mechanism 6 (e.g., an expansion and contraction speed (mm/s) of the spindle drive mechanism). Similarly, a “displacement amount of the opening and closing body 5” and a “position of the opening and closing body 5” may include not only the displacement amount and position of the opening and closing body 5 itself but also the number of rotations or the rotation angle of the motor 11 and a stroke amount of the drive mechanism 6.

In the present embodiment, as an example of the “movement speed of the opening and closing body 5”, the rotation speed of the motor 11 is to be controlled. In the following description, the “displacement amount of the opening and closing body 5” and the “position of the opening and closing body 5” may refer to the number of rotations of the motor 11. The term “movement speed” may simply refer to an actual value or the detected value Vd of the movement speed (the rotation speed of the motor 11).

The speed detection unit 24 detects the movement speed of the opening and closing body 5 (the rotation speed of the motor 11) on the basis of the detection signal from the rotation sensor 12. The speed detection unit 24 sequentially measures the detected value Vd of the movement speed regardless of whether the automatic control is being executed or not. In the process of deriving the movement speed, the speed detection unit 24 sequentially measures the displacement amount and the position of the opening and closing body 5 on the basis of the detection signal output from the rotation sensor 12.

The target value setting unit 25 refers to a map, a table, an arithmetic expression, or the like stored in the storage unit 21 during the execution of the automatic control, and sets the target value Vs of the movement speed of the opening and closing body 5 (the rotation speed of the motor 11). The target value setting unit 25 sequentially sets the target value Vs to be variable.

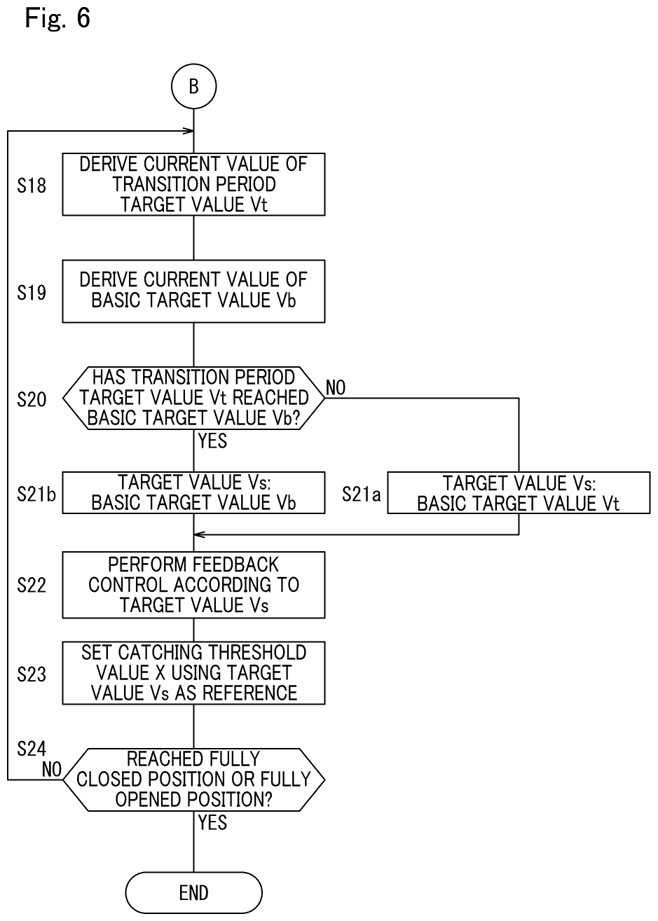

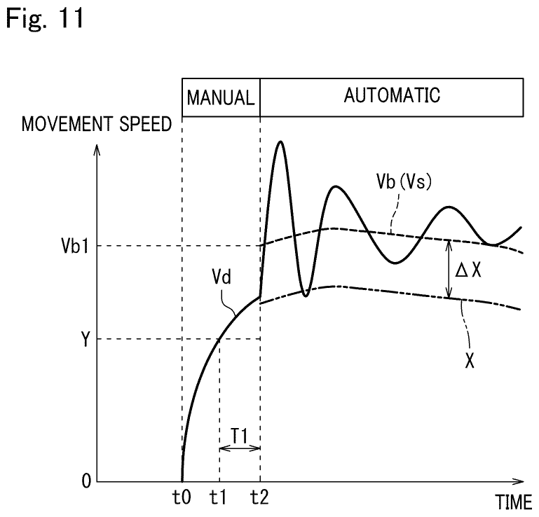

When the user's body or baggage is caught by the opening and closing body 5 during the execution of the automatic control, the movement speed excessively decreases with respect to the target value Vs. The catching detection unit 26 sets a catching threshold value X that is lower than the target value Vs by a predetermined decrease amount ΔX (see FIGS. 6 and 11). The catching detection unit 26 compares the detected value Vd with the catching threshold value X, and determines that catching has occurred when the detected value Vd is less than the catching threshold value X. When catching is detected, the motor control unit 23 stops or reversely rotates the motor 11 to interrupt the automatic control.

Automatic control starts under roughly two situations. A first situation is a case where the input unit 22 has acquired the start command from the start command output unit 13. The target value setting unit 25 sets a basic target value Vb as the target value Vs.

In the following description, “set the basic target value Vb as the target value Vs” includes, according to a context, a case of setting a mode for deriving the target value Vs according to a profile of the basic target value Vb, and a case of deriving a current value of the basic target value Vb on the basis of the displacement amount of the opening and closing body 5 with reference to the profile and setting the derived current value as the target value Vs to be compared with the detected value Vd. The same applies to a transition period target value Vt to be described later.

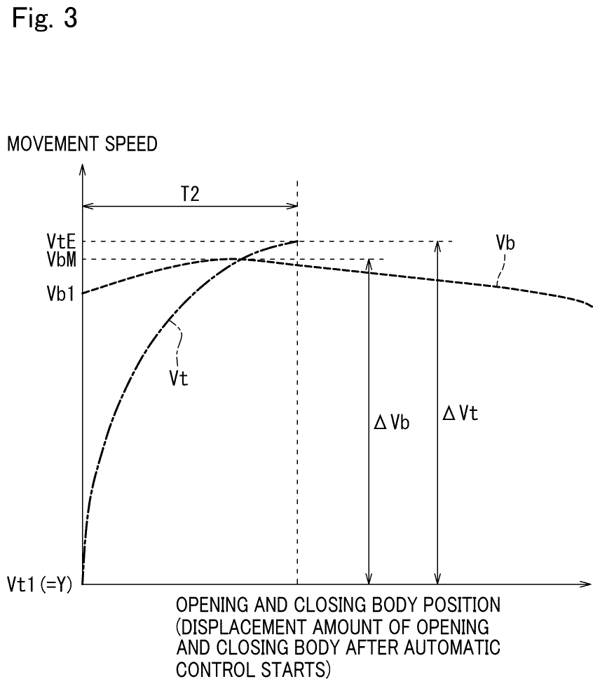

As visualized by a broken line in FIG. 3, the storage unit 21 stores in advance the profile for the basic target value Vb defining a correspondence relationship between an input parameter and the basic target value Vb. The profile is realized by a map, a table, an arithmetic expression, or the like. The input parameter for deriving the basic target value Vb is, for example, a displacement amount of the opening and closing body 5 after the start of the automatic control. The target value setting unit 25 refers to the profile stored in the storage unit 21, and sets the current value of the basic target value Vb on the basis of a current value of the input parameter.

Note that the input parameter is not limited only to the displacement amount of the opening and closing body 5, and may be the position of the opening and closing body 5 that is displaced with a lapse of an execution time of the automatic control, an elapsed time from the start time point of the automatic control, or a combination thereof. In the following description, the “basic target value Vb” may refer to a profile, to a current value, or to both, depending on the context. The same applies to a transition period target value Vt to be described later.

The basic target value Vb is variably set according to the displacement amount of the opening and closing body 5. Since the displacement amount of the opening and closing body 5 gradually increases with the progress of the automatic control, the basic target value Vb changes with the lapse of the execution time of the automatic control (see FIG. 3). During the execution of the automatic control, the basic target value Vb stably changes at a relatively high value. The basic target value Vb gradually increases from an initial value Vb1 to a maximum value VbM and gradually decreases from the maximum value VbM.

A second situation is a case where a predetermined switching condition is satisfied after the user manually operates the opening and closing body 5. Here, the “manual operation” is different from the “user's operation” associated with the start command described above, and refers to directly applying, to the opening and closing body 5, an operation force for causing the opening and closing body 5 to move. When the manual operation is performed, the manual operation is conditionally switched to the automatic control. For example, after the user manually operates the opening and closing body 5 in an opening direction in a state where the opening and closing body 5 is at the fully closed position or a half-open position, the automatic control is started when the opening and closing body 5 moves at a certain movement speed away from the fully closed position. The same applies to a case where manual operation is performed in a closing direction in a state where the opening and closing body 5 is at the fully opened position or the half-open position.

The controller 20 further includes a manual operation detection unit 27 and a switching unit 28 in order to start automatic control in the second situation.

The manual operation detection unit 27 detects manual operation of the opening and closing body 5. More specifically, when the speed detection unit 24 detects a movement speed exceeding a predetermined value (e.g., zero) in a period in which the automatic control is not executed, the manual operation detection unit 27 determines that the manual operation by the user is performed.

When the manual operation is detected, the switching unit 28 determines whether or not a switching condition for switching the manual operation to the automatic control is satisfied. When determining that the switching condition is satisfied, the switching unit 28 causes the motor control unit 23 to start the automatic control. As a result, even if the user stops the manual operation (even if the operation force from the user is unloaded), the movement of the opening and closing body 5 automatically continues.

As an example, the switching condition is a condition that the movement speed during the manual operation is maintained at or above a switching threshold value Y for a predetermined switching determination period T1. When the movement speed reaches the switching threshold value Y, the switching unit 28 measures a time from that time point. When the measurement time reaches the switching determination period T1 without the movement speed falling below the switching threshold value Y, the switching unit 28 determines that the switching condition is satisfied.

Here, FIG. 11 illustrates a comparative example of the automatic control started under the second situation. At a time point t0, the manual operation starts, and thereafter, the movement speed increases from zero. At a time point t1, the movement speed reaches the switching threshold value Y. The movement speed continues to exceed the switching threshold value Y for the switching determination period T1 after the time point t1. Therefore, at a time point t2 which is the end of the switching determination period T1, the switching condition is satisfied and the automatic control starts. In the following description, the time point t0 may be referred to as a manual operation start time point, the time point t1 may be referred to as a threshold value arrival time point, and the time point t2 may be referred to as an automatic control start time point.

In the comparative example, the target value setting unit 25 sets the basic target value Vb as the target value Vs at the automatic control start time point t2. Since the switching threshold value Y is a value lower than the basic target value Vb, the movement speed at the automatic control start time point t2 may be significantly lower than the initial value Vb1 of the basic target value Vb.

Immediately after the start of the automatic control, the motor control unit 23 sets the duty ratio to a high value so that the excessively small detected value Vd follows the target value Vs. As a result, the movement speed might greatly exceed the target value Vs. Then, the motor control unit 23 resets the duty ratio to a low value so that the excessively large detected value Vd follows the target value Vs. As a result, conversely, the movement speed might be significantly lower than the target value Vs. The behavior of the opening and closing body 5 becomes unstable due to the occurrence of overshooting and undershooting, and due to time required for attenuation thereof.

In addition, at the time of undershooting, the detected value Vd might fall below the catching threshold value X. Even if the catching threshold value X is optimized so that presence or absence of catching can be accurately determined in the automatic control started under the first situation, the catching detection unit 26 might erroneously detect the basic target value Vb when set as the target value Vs in the automatic control started under the second situation. Then, the movement of the opening and closing body 5 stops inappropriately.

By contrast, in the present embodiment, the above problems occurring in the comparative example can be solved.

In the present embodiment, when the automatic control is started under the second situation, the target value setting unit 25 does not immediately set the basic target value Vb as the target value Vs. The target value setting unit 25 sets the transition period target value Vt as the target value Vs in preference to the basic target value Vb.

As visualized by a chain line in FIG. 3, the storage unit 21 stores in advance the profile for the transition period target value Vt that defines a correspondence relationship between the input parameters and the transition period target value Vt. The profile is realized by a map, a table, an arithmetic expression, or the like. The input parameter for deriving the transition period target value Vt is also similar to that for the basic target value Vb.

A profile of the transition period target value Vt is set within a limited transition section T2. The transition period target value Vt gradually increases from a start of the transition section T2 to an end of the transition section T2. The transition period target value Vt takes an initial value Vt1 at the start (i.e., the start time point of the automatic control) of the transition section T2, gradually rises from the initial value Vt1, and takes an extreme value VtE at the end of the transition section T2.

In the illustrated example, the transition period target value Vt rises so as to draw an upwardly convex curve (e.g., a parabola) from the initial value Vt1 to the extreme value VtE, and a rate of change of the transition period target value Vt (i.e., an increase amount of the transition period target value Vt per unit displacement amount of the opening and closing body 5) decreases toward the end of the transition section T2. However, this is an example, and the transition period target value Vt may rise along a downward convex curve, may rise linearly, or may rise stepwise. The rate of change in the profile of the transition period target value Vt is steeper than a rate of change from the initial value Vb1 to the maximum value VbM of the profile of the basic target value Vb.

In the present embodiment, a predetermined fixed value is set as the initial value Vt1. As an example of the fixed value, the switching threshold value Y is applied. The transition period target value Vt gradually changes from the initial value Vt1 according to the profile described above. At the automatic control start time point t2, the basic target value Vb is larger than the switching threshold value Y and the transition period target value Vt. The transition period target value Vt gradually changes from the switching threshold value Y as the initial value Vt1 toward the basic target value Vb.

A difference ΔVt between the initial value Vt1 and the extreme value VtE is larger than a difference ΔVb between the switching threshold value Y and the maximum value VbM of the basic target value Vb. Therefore, when the initial value Vt1 is set as the switching threshold value Y, the extreme value VtE becomes larger than the maximum value VbM. Therefore, in the transition section T2, the transition period target value Vt gradually changes from the initial value Vt1 toward the basic target value Vb and reaches the basic target value Vb.

The target value setting unit 25 sets the transition period target value Vt as the target value Vs until the transition period target value Vt reaches the basic target value Vb, and sets the basic target value Vb as the target value Vs after the transition period target value Vt reaches the basic target value Vb. Hereinafter, a time point when the transition period target value Vt reaches the basic target value Vb, in other words, a time point when the target value Vs is switched from the transition period target value Vt to the basic target value Vb, is referred to as a target value switching time point t3.

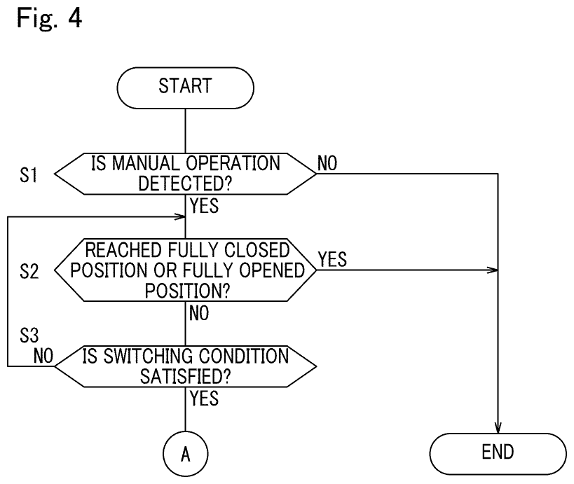

Although partly overlapping the above description, a control method executed by the opening and closing body control device 10 will be described with reference to FIGS. 4 to 6. The processing illustrated in FIGS. 4 to 6 is started when the automatic control is not executed.

With reference to FIG. 4, first, the manual operation detection unit 27 determines whether manual operation has been performed or not (Step S1). When the manual operation is not detected (S1: NO), the processing ends. When the manual operation is detected (S1: YES), the speed detection unit 24 specifies a movement direction of the opening and closing body 5, and the switching unit 28 determines whether the opening and closing body 5 has reached a limit position (the fully opened position in a case of the opening direction, the fully closed position in a case of the closing direction) in the movement direction (Step S2). Furthermore, the switching unit 28 determines whether or not the switching condition is satisfied (Step S3).

When the opening and closing body 5 reaches the fully opened position or the fully closed position while the switching condition is yet to be satisfied (S3: NO, S2: YES), the processing ends without executing the automatic control. When the switching condition is satisfied before the opening and closing body 5 reaches the fully opened position or the fully closed position (S2: NO, S3: YES), the automatic control is started.

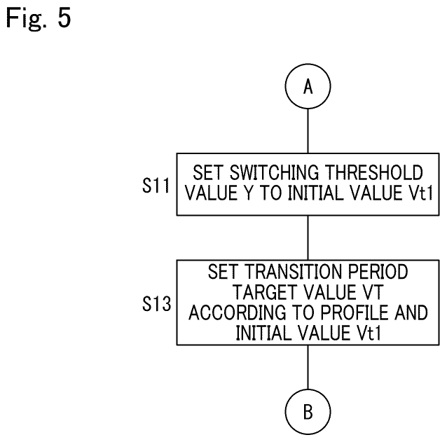

With reference to FIG. 5, when the automatic control is started during the manual operation, the target value setting unit 25 sets the switching threshold value Y as an example of a predetermined fixed value to be the initial value Vt1 of the transition period target value Vt (Step S11). The target value setting unit 25 sets the transition period target value Vt (in more detail, a correspondence relationship between the displacement amount of the opening and closing body 5 and the transition period target value Vt) according to the profile for the transition period target value Vt stored in the storage unit 21 and the set initial value Vt1 (the switching threshold value Y) (Step S13).

With reference to FIG. 6, the target value setting unit 25 derives a current value of the transition period target value Vt according to a displacement amount of the opening and closing body 5 from the automatic control start time point t2 (Step S18), and derives a current value of the basic target value Vb (Step S19). The target value setting unit 25 determines whether the transition period target value Vt has reached the basic target value Vb or not (Step S20). If the transition period target value Vt has not reached the basic target value Vb (S20: NO), the target value setting unit 25 sets the transition period target value Vt as the target value Vs (Step S21a). When the transition period target value Vt has reached the basic target value Vb (S20: YES), the target value setting unit 25 sets the basic target value Vb as the target value Vs (Step S21b).

The motor control unit 23 executes feedback control on the basis of the target value Vs set in Steps S21a and S21b (Step S22). In other words, the motor control unit 23 controls the duty ratio of the PWM signal to be supplied to the motor 11 of the drive mechanism 6 according to the deviation of the detected value Vd of the movement speed from the current value of the set target value Vs. Even at the automatic control start time point t2, the motor control unit 23 sets the duty ratio according to the detected value Vd of the movement speed. On the other hand, the catching detection unit 26 sets the catching threshold value X using, as a reference, the currently set target value Vs, and determines whether catching is present or not (Step S23). Although not illustrated in the flowchart, when catching is detected, the motor control unit 23 stops or reversely rotates the motor 11 to interrupt the automatic control.

The speed detection unit 24 determines whether the opening and closing body 5 has reached the limit position or not (Step S24). When the opening and closing body 5 has not reached the limit position (S24: NO), basically, the processing returns to Step S18 to repeat the processing. When the opening and closing body 5 has not reached the limit position and the transition period target value Vt has already reached the basic target value Vb (S20: YES, S24: NO), the processing of deriving the current value of the transition period target value Vt may be omitted. By repeating the processing, the opening and closing body 5 automatically approaches the limit position. When the opening and closing body 5 reaches the limit position (S24: YES), the automatic control ends.

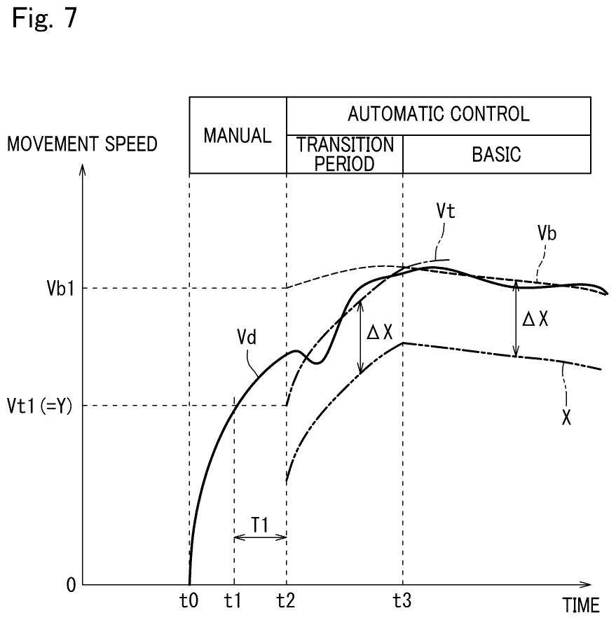

FIG. 7 illustrates an example of a transition of the movement speed in a case where the above control method is executed. Similarly to the comparative example illustrated in FIG. 11, the movement speed of the opening and closing body 5 gradually increases from the manual operation start time point t0 to the automatic control start time point t2 by the manual operation by the user. In this increasing process, the movement speed reaches the switching threshold value Y. During the switching determination period T1 from the threshold value arrival time point t1 to the automatic control start time point t2, the movement speed is maintained at or above the switching threshold value Y. The switching condition is satisfied at the automatic control start time point t2 to start the automatic control.

In the present embodiment, a correspondence relationship between the displacement amount of the opening and closing body 5 and the transition period target value Vt is set after the start of the automatic control. The transition period target value Vt is continuously set as the target value Vs from the automatic control start time point t2 to the target value switching time point t3.

The initial value Vt1 of the transition period target value Vt is set to the switching threshold value Y. Therefore, the deviation of the detected value Vd from the target value Vs at the automatic control start time point t2 is small as compared with the comparative example illustrated in FIG. 11. Therefore, overshooting and undershooting are less likely to occur, or an amount of excess can be reduced, and the detected value Vd satisfactorily follows the target value Vs. At the automatic control start time point t2, the motor control unit 23 sets the duty ratio according to the detected value Vd of the movement speed. The duty ratio at the start of the feedback control is set according to the movement speed when the manual operation is switched to the automatic control or immediately before the switching. Therefore, stability of the feedback control at the time of switching from the manual operation to the automatic control and immediately after the switching is improved.

The transition period target value Vt gradually changes from the initial value Vt1 toward the basic target value Vb. The target value Vs gradually increases accordingly. Since the deviation at the automatic control start time point t2 is reduced, the detected value Vd satisfactorily follows the target value Vs during the gradual increase of the target value Vs.

After the target value switching time point t3, the target value Vs is switched to the basic target value Vb. The detected value Vd satisfactorily follows the target value Vs before the target value switching time point t3 to keep a state in which the deviation of the detected value Vd from the target value Vs is small. Therefore, the detected value Vd satisfactorily follows the target value Vs even after the target value switching time point t3.

As described above, the present embodiment enables elimination or suppression of overshooting and undershooting that may occur in the comparative example after the switching from the manual operation to the automatic operation. Therefore, after the switching from the manual operation to the automatic operation, the opening and closing body 5 can be continuously moved naturally.

By eliminating the undershooting, it is possible to avoid a situation in which the movement speed falls below the catching threshold value X even though no catching occurs. Furthermore, the catching threshold value X is set using the currently set target value Vs as a reference. In an initial stage of the start of the automatic control, the catching threshold value X is set using the transition period target value Vt as a reference. Therefore, the catching threshold value X itself is smaller than that of the comparative example. Therefore, erroneous detection of catching can be prevented.

In addition, in the present embodiment, a predetermined value (as an example, the switching threshold value Y) is set as the initial value Vt1 of the transition period target value Vt. The profile of the transition period target value Vt is also fixed. Therefore, the configuration of the opening and closing body control device 10 is simplified in terms of software.

As described above, in the present embodiment, the profile of the transition period target value Vt, the initial value Vt1 of the transition period target value Vt, and the profile of the basic target value Vb are all fixed. Then, when these specifications are decided, the displacement amount or position of the opening and closing body 5 when the transition period target value Vt reaches the basic target value Vb can be derived, and this displacement amount or position is also fixed.

Therefore, the determination processing (Step S20) as to whether or not the transition period target value Vt has reached the basic target value Vb does not always need to be executed on the basis of the comparison between the current value of the basic target value Vb and the current value of the transition period target value Vt. The target value setting unit 25 may determine whether or not the transition period target value Vt has reached the basic target value Vb on the basis of the displacement amount of the opening and closing body 5 or whether or not the position thereof is the fixed predetermined position.

Note that the fixed value set as the initial value Vt1 is not limited to the switching threshold value Y, and may be, for example, a predetermined value higher or a predetermined value lower than the switching threshold value Y. Since the switching condition is satisfied when the movement speed is equal to or higher than the switching threshold value Y, the deviation of the detected value Vd from the target value Vs at the automatic control start time point t2 can be further reduced.

### Second Embodiment

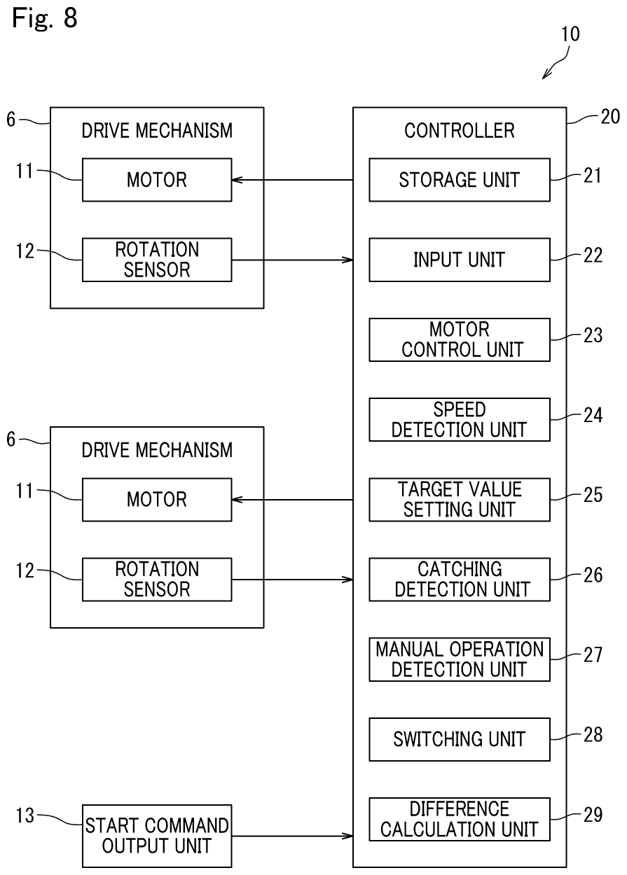

Next, an opening and closing body control device 10 according to a second embodiment will be described with reference to FIGS. 8, 9, and 10A to 10C, focusing on differences from the first embodiment. Also in the present embodiment, similarly to the first embodiment, the automatic control is started during the manual operation, and the transition period target value Vt is set as the target value Vs at the initial stage of the start of the automatic control. The present embodiment is different from the first embodiment in that the profile of the transition period target value Vt is corrected according to the situation at the automatic control start time point t2, and that the initial value Vt1 of the transition period target value Vt is not a fixed value but is set according to the situation at the automatic control start time point t2.

With reference to FIG. 8, the controller 20 further includes a difference calculation unit 29. The difference calculation unit 29 calculates a difference ΔV between the detected value Vd of the movement speed and the basic target value Vb (in particular, its initial value Vb1) at the automatic control start time point t2.

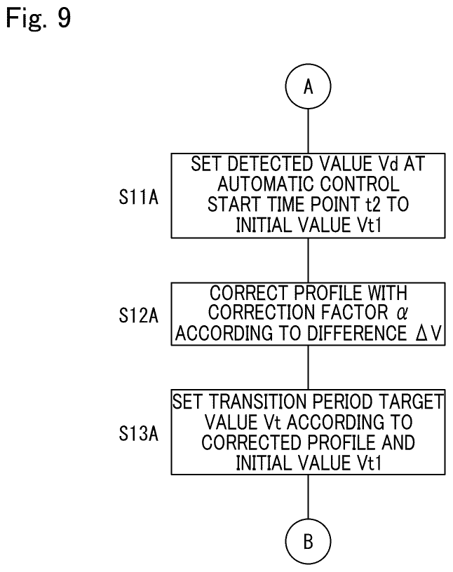

Also in the present embodiment, the processing shown in FIGS. 4 and 6 is executed as in the first embodiment. In the present embodiment, processing illustrated in FIG. 9 is executed instead of the processing illustrated in FIG. 5.

With reference to FIG. 9, in the present embodiment, when the automatic control is started during the manual operation, the target value setting unit 25 sets the initial value Vt1 of the transition period target value Vt according to the detected value Vd at the automatic control start time point t2. Specifically, the detected value Vd at the automatic control start time point t2 is set to the initial value Vt1 of the transition period target value Vt (Step S11A).

Next, the target value setting unit 25 sets a correction factor α according to the difference αV calculated by the difference calculation unit 29, and corrects the profile of the transition period target value Vt with the correction factor α (Step S12A). The profile to be corrected is the same as that of the first embodiment (see FIG. 3), and is stored in the storage unit 21 in advance.

The target value setting unit 25 sets the transition period target value Vt (in more detail, the correspondence relationship between the displacement amount of the opening and closing body 5 and the transition period target value Vt) according to the corrected profile and the set initial value Vt1 (Step S13A).

For the processing of Step S12A, the target value setting unit 25 multiplies the extreme value VtE of the profile for the transition period target value Vt by the correction factor α. As a result, the extreme value VtE is corrected, and the difference ΔVt between the initial value Vt1 and the extreme value VtE is corrected.

A section between the initial value Vt1 and a corrected extreme value αVtE is also corrected within a range in which the tendency of the profile is not changed. For example, when the original profile is an upwardly convex curve, the target value setting unit 25 corrects the section between the initial value Vt1 and the corrected extreme value αVtE so that the corrected profile also draws a similar curve.

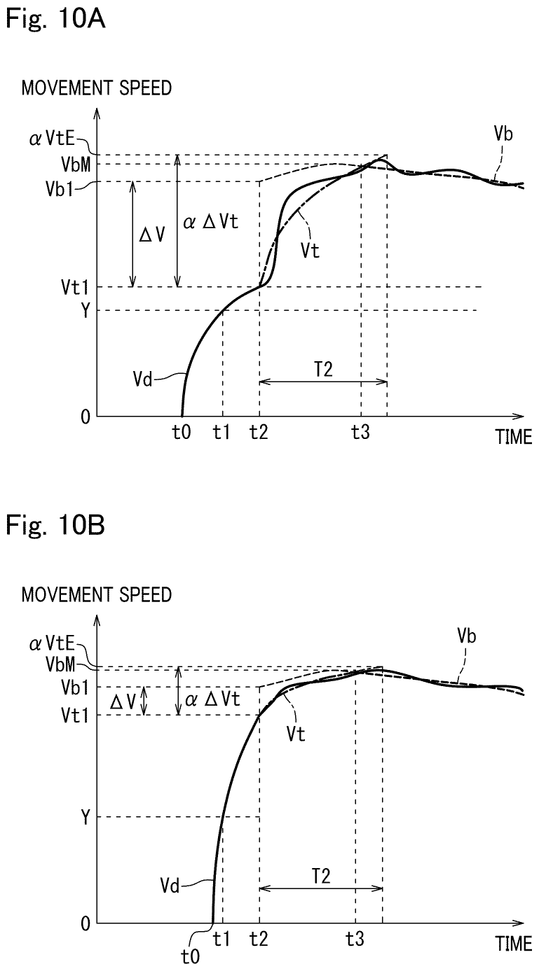

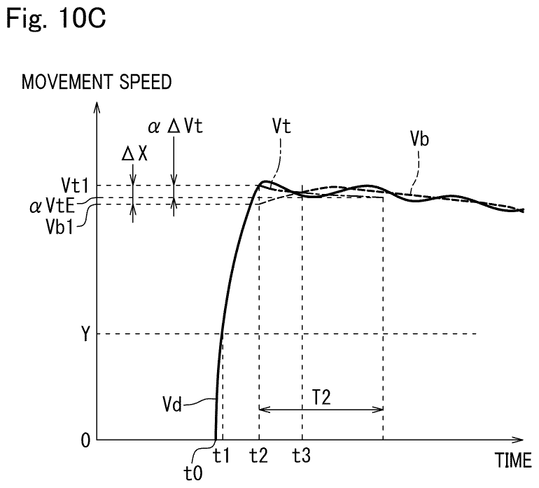

The correction factor α is less than one. Here, it is assumed that the difference ΔV is obtained by subtracting the detected value Vd from the basic target value Vb. As illustrated in FIGS. 10A and 10B, typically, the detected value Vd at the automatic control start time point t2 is smaller than the initial value Vb1 of the basic target value Vb, and the difference ΔV is positive. At this time, the correction factor α is a positive value less than one. As the difference ΔV increases, the correction factor α becomes a value closer to one.

Due to the characteristics of the switching condition, at the automatic control start time point t2, the detected value Vd is at least the switching threshold value Y. Although not illustrated in detail, when the detected value Vd is the switching threshold value Y, the difference ΔV is a substantially positive maximum value. At this time, the correction factor α is set to one, and the original profile is applied without being corrected.

In the example illustrated in FIG. 10B, the difference ΔV is smaller than that in the example illustrated in FIG. 10A. As the difference ΔV is smaller, i.e., as the detected value Vd is closer to the basic target value Vb, the correction factor α is closer to zero. The corrected extreme value ΔVtE approaches the initial value Vt1, and a corrected difference αΔVt approaches zero. The target value setting unit 25 corrects the profile of the transition period target value Vt such that the smaller the difference ΔV is, the slower the change in the transition period target value Vt becomes with respect to the displacement amount of the opening and closing body 5.

When the difference ΔV is positive and the detected value Vd is set as the initial value Vt1, the target value setting unit 25 sets the correction factor α such that the corrected extreme value a VtE becomes larger than the maximum value VbM of the basic target value Vb. As a result, the corrected transition period target value Vt can reach the basic target value Vb within the transition section T2.

According to the present embodiment, when the automatic control is started, the initial value Vt1 of the transition period target value Vt is set according to the detected value Vd at that time. Specifically, the initial value Vt1 of the transition period target value Vt is set to the detected value Vd at that time. Therefore, regardless of the strength of the manual operation, a deviation of the detected value Vd from the target value Vs at the automatic control start time point t2 can be reduced to the minimum. In addition, when the initial value Vt1 is set to a value higher than the switching threshold value Y, the extreme value VtE is corrected to decrease accordingly to make slow the rate of change of the transition period target value Vt. Therefore, the transition period target value Vt can be gradually shifted to the basic target value Vb. This enables the detected value Vd to continue to satisfactorily follow the target value Vs, and enables the opening and closing body 5 to continue to move naturally.

As illustrated in FIG. 10C, when momentum of the manual operation is strong, the detected value Vd at the automatic control start time point t2 becomes larger than the initial value Vb1 of the basic target value Vb, and the difference ΔV may become negative. At this time, the correction factor α is a negative value. As the difference ΔV increases, the correction factor α becomes a value farther from zero. When the correction factor α is negative, the extreme value αVtE becomes lower than the initial value Vt1, and the tendency of the profile is reversed using the horizontal axis as a reference. For example, in a case where the original profile is an upwardly convex curve, the corrected profile is a downwardly convex curve.

When the difference ΔV is negative and the detected value Vd is set as the initial value Vt1, the target value setting unit 25 sets the correction factor α such that the corrected extreme value ΔVtE becomes smaller than the maximum value VbM of the basic target value Vb. As a result, the corrected transition period target value Vt gradually decreases from the automatic control start time point t2 and can reach the basic target value Vb within the transition section T2.

Also in this case, similarly to the first embodiment and the examples illustrated in FIGS. 10A and 10B, the detected value Vd can continue to satisfactorily follow the target value Vs, and the opening and closing body 5 can continue to move naturally.

The setting of the initial value Vt1 is not limited to the detected value Vd, and may be a value higher or lower than the detected value Vd using the detected value Vd as a reference.

Although the embodiments have been described so far, the above configurations can be appropriately changed within the scope of the gist of the present invention.

What is claimed is:

1. An opening and closing body control device comprising:
a drive mechanism that drives an opening and closing body configured to open and close an opening part of a vehicle body;
a speed detection unit that detects a movement speed of the opening and closing body;
a manual operation detection unit that detects manual operation of the opening and closing body;
a control unit that executes automatic control by feedback control of movement of the opening and closing body so as to cause a detected value of the movement speed to follow a target value;
a target value setting unit capable of setting, as the target value, a basic target value that changes according to an elapsed time or a displacement of the opening and closing body from a start time point of the automatic control; and
a switching unit that causes the control unit to start the automatic control when a switching condition that the movement speed during detection of the manual operation is equal to or higher than a switching threshold value lower than the basic target value is satisfied, wherein
when the automatic control is started upon satisfaction of the switching condition, the target value setting unit sets, as the target value, a transition period target value gradually changing from an initial value toward the basic target value in preference to the basic target value.

2. The opening and closing body control device according to claim 1, wherein a predetermined value is set as the initial value of the transition period target value.

3. The opening and closing body control device according to claim 1, wherein the initial value of the transition period target value is set according to the detected value of the movement speed at a start time point of the automatic control.

4. The opening and closing body control device according to claim 3, further comprising
a difference calculation unit that calculates a difference between the detected value of the movement speed and the basic target value at the start time point of the automatic control, wherein
the target value setting unit corrects the transition period target value according to the difference.

5. The opening and closing body control device according to claim 4, wherein the target value setting unit corrects the transition period target value such that the smaller the difference is, the slower a change in the transition period target value becomes.

6. The opening and closing body control device according to claim 1, wherein
the control unit controls a duty ratio of a PWM signal supplied to the drive mechanism according to a deviation of the detected value of the movement speed from the target value, and
the control unit sets the duty ratio according to the detected value of the movement speed at a start time point of the automatic control.

7. The opening and closing body control device according to claim 1, wherein the target value setting unit sets the transition period target value as the target value until the transition period target value reaches the basic target value after the automatic control is started, and sets the basic target value as the target value after the transition period target value reaches the basic target value.

8. The opening and closing body control device according to claim 1, further comprising
a catching detection unit that sets a catching threshold value lower than the target value by a predetermined decrease amount and compares the detected value of the movement speed with the catching threshold value to detect catching, wherein
when the automatic control is started, the catching detection unit sets the catching threshold value using, as a reference, the transition period target value set as the target value.

9. The opening and closing body control device according to claim 2, wherein
the control unit controls a duty ratio of a PWM signal supplied to the drive mechanism according to a deviation of the detected value of the movement speed from the target value, and
the control unit sets the duty ratio according to the detected value of the movement speed at a start time point of the automatic control.

10. The opening and closing body control device according to claim 3, wherein
the control unit controls a duty ratio of a PWM signal supplied to the drive mechanism according to a deviation of the detected value of the movement speed from the target value, and
the control unit sets the duty ratio according to the detected value of the movement speed at a start time point of the automatic control.

11. The opening and closing body control device according to claim 2, wherein the target value setting unit sets the transition period target value as the target value until the transition period target value reaches the basic target value after the automatic control is started, and sets the basic target value as the target value after the transition period target value reaches the basic target value.

12. The opening and closing body control device according to claim 3, wherein the target value setting unit sets the transition period target value as the target value until the transition period target value reaches the basic target value after the automatic control is started, and sets the basic target value as the target value after the transition period target value reaches the basic target value.

13. The opening and closing body control device according to claim 2, further comprising
a catching detection unit that sets a catching threshold value lower than the target value by a predetermined decrease amount and compares the detected value of the movement speed with the catching threshold value to detect catching, wherein
when the automatic control is started, the catching detection unit sets the catching threshold value using, as a reference, the transition period target value set as the target value.

14. The opening and closing body control device according to claim 3, further comprising
a catching detection unit that sets a catching threshold value lower than the target value by a predetermined decrease amount and compares the detected value of the movement speed with the catching threshold value to detect catching, wherein
when the automatic control is started, the catching detection unit sets the catching threshold value using, as a reference, the transition period target value set as the target value.
